(19) United States
(12) Patent Application Publication
(10) Pub. No.: US 2003/0021230 A1
(43) Pub. Date: Jan. 30, 2003

(54) Switch fabric with bandwidth efficient flow control

(75) Inventors: Tzu-Jen Kuo, San Jose, CA (US); Dipak Shah, San Jose, CA (US)

Correspondence Address: BEYER WEAVER & THOMAS LLP, P.O. BOX 778, BERKELEY, CA, 94704-0778, US

(73) Assignee: PetaSwitch Solutions, Inc.

(21) Appl. No.: 09/802,434

(22) Filed: Mar. 9, 2001

(51) Int. Cl. H04L 1/00; H04J 1/16; H04J 3/14

(52) U.S. Cl. 370/230; 370/412

(57) ABSTRACT

An improved approach for applying flow control within a switch system is disclosed. The improved approach makes use of scheduling operations performed by the switch system to implement receive-side flow control. Transmit-side flow control is independently provided. The improved approach of the invention enables the switch system to provide flow control in a bandwidth efficient manner.

### CROSS REFERENCE TO RELATED APPLICATION

This application is related to U.S. application Ser. No. 09/759,434, filed Jan. 12, 2001, and entitled “SWITCH FABRIC CAPABLE OF AGGREGATING MULTIPLE CHIPS AND LINKS FOR HIGH BANDWIDTH OPERATION”, the content of which is hereby incorporated by reference.

### BACKGROUND OF THE INVENTION

1. Field of the Invention

The present invention relates to network switching devices and, more particularly, to high bandwidth switching devices.

2. Description of the Related Art

Switching systems conventionally perform flow control to prevent loss of data while switching. More particularly, when queues that store the data being switched near their storage capacity limits, flow control is performed to stop or slow the amount of data being subsequently sent to the queues so as to prevent loss of data. The case where flow control stops the flow of additional data is commonly referred to as back pressure.

Unfortunately, however, conventional approaches to flow control consume large amounts of the bandwidth of the switching system. As communication markets continue their strong growth, the bandwidth needed to satisfy the demands of the information age increases. Thus, there is a need for improved approaches to flow control that are efficient in their use of available switching system bandwidth.

### SUMMARY OF THE INVENTION

Broadly speaking, the invention relates to an improved approach for applying flow control within a switch system. The improved approach makes use of scheduling operations performed by the switch system to implement receive-side flow control. Transmit-side flow control is independently provided. The improved approach of the invention enables the switch system to provide flow control in a bandwidth efficient manner.

The invention can be implemented in numerous ways including, as an apparatus, system, device, method, or a computer readable medium. Several embodiments of the invention are discussed below.

As a method for managing congestion of traffic at a plurality of ports of a switch system having at least a scheduler, one embodiment of the invention includes at least the operations of: monitoring outgoing traffic at the ports of the switch to identify traffic conditions at each of the ports; notifying the scheduler of the switch system of the traffic conditions; and scheduling of traffic to the ports by the scheduler based in part on the traffic conditions.

As a method for applying flow control to a multi-port switch system having at least a scheduler, one embodiment of the invention includes at least the operations of: detecting congestion at a particular port of the multi-port switch system; notifying the scheduler of the detected congestion; and restricting granting of requests to send additional data to the particular port of the multi-port switch system to ameliorate the detected congestion at the particular port.

As a method for managing congestion of traffic at a plurality of ports of a switch system having at least a scheduler, one embodiment of the invention includes at least the operations of: monitoring outgoing traffic at the ports of the switch to identify traffic conditions at each of the ports; determining whether flow control is desired based on the traffic conditions; notifying the scheduler of the switch system of the traffic conditions when said determining determines that flow control is desired; and altering scheduling of traffic to the ports based on the traffic conditions provided to the scheduler by said notifying.

As a method for managing congestion of traffic at a plurality of ports of a switch system having at least a scheduler, one embodiment of the invention includes at least the operations of: monitoring outgoing traffic at the ports of the switch to identify traffic conditions at each of the ports; producing flow control information for each of the ports based on the traffic conditions at each of the ports; and altering scheduling of traffic to the ports based on the flow control information.

As a switch system, one embodiment of the invention includes at least: a switch unit that switches data through said switch system; a scheduler that receives requests to transfer blocks of data through said switch system and selectively concurrently permits one or more of the requests to transfer blocks of data through said switch unit; and a flow control manager that receives flow control information and alters the amount of or rate that requests to transfer blocks of data through said switch unit are permitted by said scheduler based on the flow control information.

As a switch system, another embodiment of the invention includes at least: a switch unit that switches data through said switch system; and a scheduler that receives requests to transfer blocks of data through said switch system, receives flow or traffic information, and selectively concurrently permits one or more of the requests to transfer blocks of data through said switch unit in accordance with the flow or traffic information such that the amount of or rate that requests to transfer blocks of data through said switch unit are altered dependent on the flow or traffic information.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a block diagram of a switch system according to one embodiment of the invention;

FIG. 2 is a flow diagram of flow control processing according to one embodiment of the invention;

FIG. 3 is a flow diagram of flow control processing according to another embodiment of the invention;

FIGS. 4A and 4B are flow diagrams of flow control processing according to a more detailed embodiment of the invention; and

FIG. 5 is a flow diagram of transmit-side flow control processing according to one embodiment of the invention;

FIG. 6A is a flow diagram of flow control processing in accordance with a flow control amount according to one embodiment of the invention; and

FIG. 6B is a flow diagram of flow control processing in accordance with a flow control amount according to another embodiment of the invention; and

FIG. 7 is a block diagram of a switch system illustrating progression of flow control events.

### DETAILED DESCRIPTION OF THE INVENTION

The invention relates to an improved approach for applying flow control within a switch system. The improved approach makes use of scheduling operations performed by the switch system to implement receive-side flow control. Transmit-side flow control is independently provided. The improved approach of the invention enables the switch system to provide flow control in a bandwidth efficient manner.

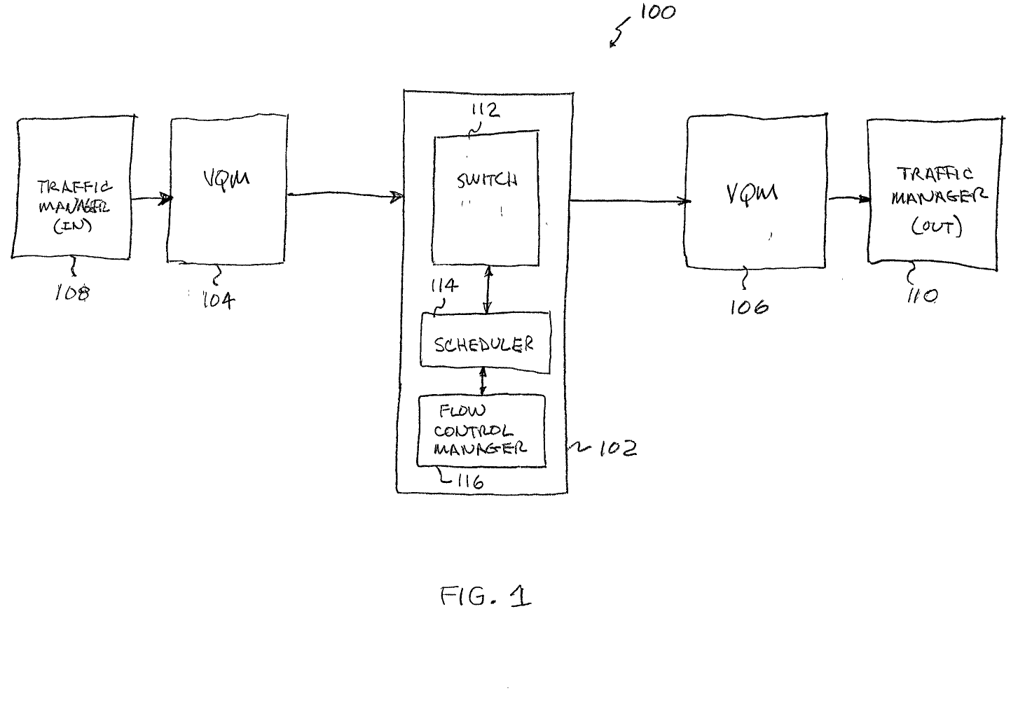

Embodiments of this aspect of the invention are discussed below with reference to FIGS. 1-7. However, those skilled in the art will readily appreciate that the detailed description given herein with respect to these figures is for explanatory purposes as the invention extends beyond these limited embodiments.

FIG. 1 is a block diagram of a switch system 100 according to one embodiment of the invention. The switch system 100 includes a switching apparatus 102 that couples between a transmit-side Virtual Queue Manager (VQM) 104 and a receive-side VQM 106. Traffic (i.e., data) is switched through the switch system 100 from a transmit-side to a receive-side. Typically, the switch system 100 supports a plurality of ports, and each port can serve as an input port or an output port for the traffic.

The switch system also includes a transmit-side traffic manager 108 and a receive-side traffic manager 110. In one embodiment, the traffic managers 108 and 110 are network processors. Traffic that is to be switched through the switch system 100 initially arrives at the transmit-side traffic manager 108. The traffic is then supplied to the transmit-side VQM 104. The transmit-side VQM 104 includes one or more virtual queues that are used to buffer (e.g., temporarily store) the traffic to be switched through the switch system 100. Thereafter, at appropriate times, the traffic at the transmit-side VQM 104 is supplied to the switching apparatus 102.

The switching apparatus 102 includes a switch 112, a scheduler 114, and a flow control manager 116. The traffic to be transmitted is buffered at the transmit-side VQM 104 and supplied to the switch 112. The scheduler 114 operates to control when and which of the buffered traffic at the transmit-side VQM 104 is supplied to the switch 112. When the traffic from the transmit-side VQM 104 arrives at the switch 112 of the switching apparatus 102, it is switched through the switch 112 to the receive-side VQM 106. The receive-side VQM 106 includes one or more virtual queues that are used to buffer (e.g., temporarily store) the traffic that has been switched through the switch system 100. The traffic is then retrieved from the one or more virtual queues within the receive-side VQM 106 by the receive-side traffic manager 110.

According to the invention, the switching apparatus 102 implements flow control to protect the one or more virtual queues within the receive-side VQM 106 from overflowing and thus losing data. In this regard, the flow control manager 116 interacts with the scheduler 114 to control the rate at which traffic is supplied to the receive-side VQM 106. For example, when a particular virtual queue of the receive-side VQM 106 becomes filled with traffic to nearly full capacity, then the flow control manager 116 is informed by the receive-side VQM 106 (or the traffic manager 110) of the need for flow control. The flow control manager 116 then interacts with the scheduler 114 to restrict or stop the flow of additional traffic to the particular virtual queue of the receive-side VQM 106. Subsequently, after the amount of traffic stored in the particular virtual queue is reduced, the flow control manager 116 is informed by the receive-side VQM 106 (or the traffic manager 110) that the flow of traffic to the particular virtual queue can now be increased. The flow control manager 116 then interacts with the scheduler 114 to start or increase the flow of additional traffic to the particular virtual queue of the receive-side VQM 106.

In switching the traffic through the switching apparatus 102, the switch 112 performs the actual switching. However, the switch 112 is typically a configurable switching device such as a concurrent switch. One example of a concurrent switch is a crossbar. Hence, the switch 112 needs to be configured to provide the appropriate switching. The configuration can be controlled by the scheduler 114 or by the traffic itself.

The scheduler 114 operates to accept or deny the one or more requests that are being made by the VQM 104 for passing data through the switch 112 to the VQM 106. The scheduler 114 arbitrates amongst a plurality of incoming requests associated with the various ports and decides which one or more of the requests to grant. The arbitration typically takes priority levels into consideration.

Although the flow control manager 116 is shown in FIG. 1 as within the switching apparatus 102, it should be understood that the flow control manager 116 could reside elsewhere in the switch system 100. For example, the flow control manager 116 could be within the VQM 106 or the traffic manager 110, or could be a stand alone entity. The flow control manager 116 interacts with the scheduler 114 to manage the flow of data through the switch 112 to the VQM 106 and/or traffic manager 110. In the case where the flow control manager 116 is within the switching apparatus 102, the flow control manager 116 can deliver flow control signals directly to the scheduler 114. On the other hand, when the flow control manager 116 is external to the switching apparatus 102 (such as within the VQM 106, the traffic manager 110, or a stand alone entity), then the flow control manager 116 can deliver flow control cells to the scheduler 114. The flow control manager 116 can also be incorporated into the scheduler 114.

Additionally, although the switch system 100 illustrates only traffic managers 108 and 110, only VQMs 104 and 106, and switching apparatus 102, it should be understood that a switch system can include substantially more traffic managers, VQMs and switching apparatuses. Often, switch systems are able to support concurrent switching between multiple input ports to multiple output ports.

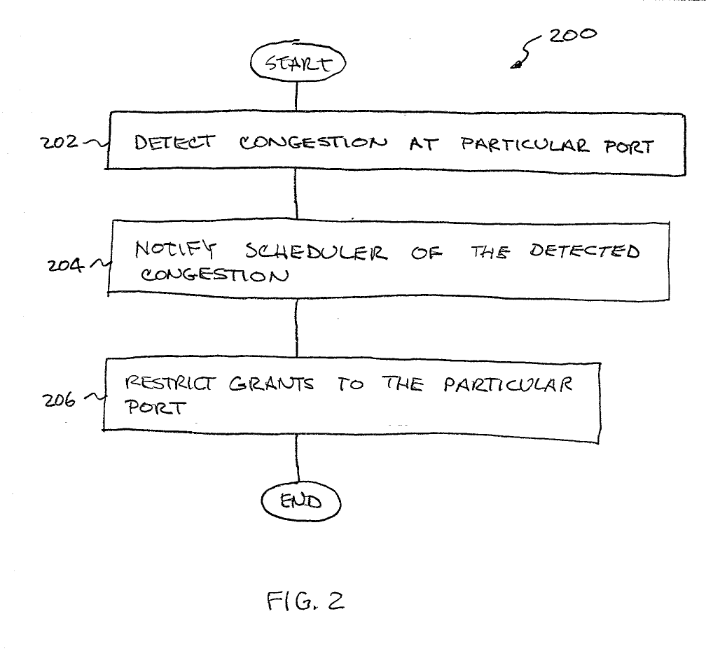

FIG. 2 is a flow diagram of flow control processing 200 according to one embodiment of the invention. The flow control processing 200 operates to restrict the amount of traffic being received through use of upstream notifications. The flow control processing 200 is, for example, performed by a multi-port switch system. As a particular example, the flow control processing 200 can, for example, be performed by the switching apparatus 102 and one or more of the receive-side VQM 106 and the traffic manager 110 illustrated in FIG. 1.

The flow control processing 200 initially detects 202 congestion at a particular port. Then, a scheduler is notified 204 of the detected congestion. The scheduler is part of the switch system and serves to control the switching of traffic through a switching apparatus (or switch) of the switch system by selectively granting one or more requests to transmit data through the switching apparatus to one or more virtual queues that buffer traffic for the ports. After the scheduler is notified 204, the scheduler operates to restrict 206 grants to the particular port that was detected as having congestion. Here, the scheduler can operate to restrict the grants once notified 204 of the detected congestion. In other words, requests to deliver data to the particular port are granted less frequently or not at all for a period of time.

It should be noted that the flow control initiated by either the receive-side VQM or the receive-side traffic manager is able to prevent overflow of its virtual queues and thus preventing potential loss of data by notifying the scheduler within the switching apparatus. The scheduler then operates to alter the manner in which requests to deliver data to the particular port are granted. Hence, the flow control information initiated at the receive-side VQM or traffic manager does not need to be transmitted or broadcast to the transmit-side VQM or its traffic manager. Instead, the flow control is implemented by the switching apparatus.

Flow control at the transmit-side of the switch system operates separately from flow control at the receive side of the switch system. In other words, the switching apparatus does not inform the transmit-side VQM or its traffic manager of the congestion at the receive-side VQM. Nevertheless, the transmit-side VQM and its traffic manager operate to independently detect when the virtual queues within the transmit-side VQM are approaching or exceeding the threshold for their storage capabilities and thus, thereafter, the transmit-side traffic manager restricts the amount of traffic supplied to the virtual queues within the transmit-side VQM. Since the switching apparatus does not inform the transmit-side VQM or its traffic manager of the congestion at the receive-side, the switch system conserves its bandwidth for switching traffic through the switch system.

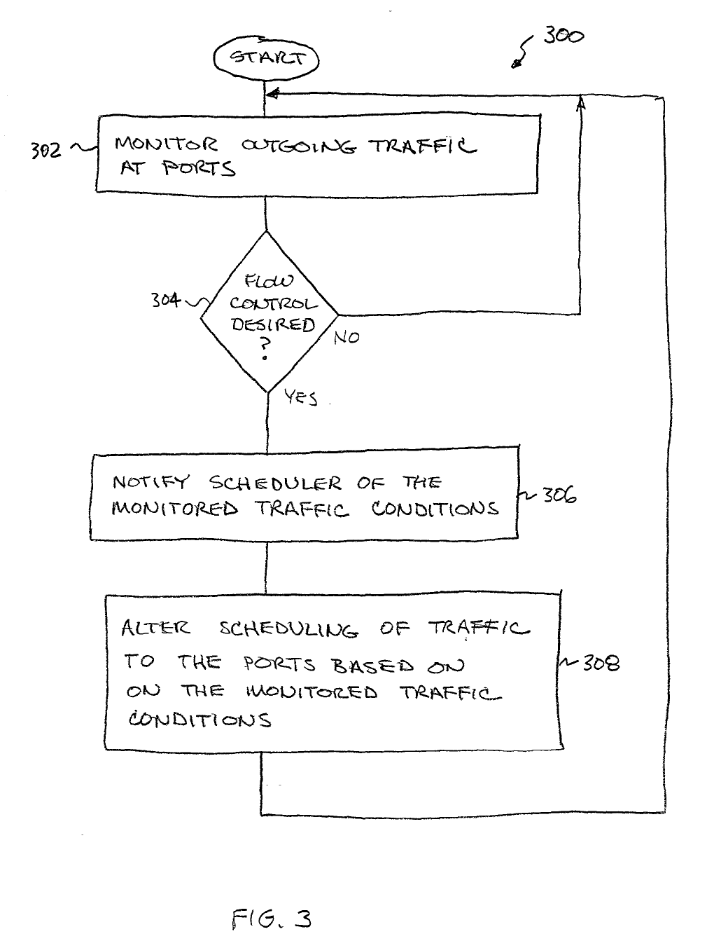

FIG. 3 is a flow diagram of flow control processing 300 according to another embodiment of the invention. The flow control processing 300 is, for example, performed by a multi-port switch system. The switch system typically includes at least receive-side virtual queues, a switch and a scheduler.

The flow control processing 300 monitors 302 outgoing traffic at ports of the switch system. Typically, the switch system supports a plurality of ports, each of which are associated with one or more virtual queues (i.e., receive-side virtual queues) that buffer traffic (e.g., data) to be output to the respective ports. Thereafter, a decision 304 determines whether flow control is desired. Here, by examining the outgoing traffic at the ports, the flow control processing 300 can determine whether the amount of outgoing traffic buffered at the ports indicates the need for flow control. For example, when the monitoring 302 indicates that the amount of outgoing traffic buffered at the ports is high, flow control can be desired to reduce the amount or rate that additional traffic is stored to these buffers. Alternatively, when the monitoring 302 indicates that the outgoing traffic buffered at the ports is low, then flow control can be used to enable higher quantities of traffic to be supplied to the buffers associated with those ports. Typically, flow control can enable higher quantities of traffic to be supplied to the buffers by unrestricting the amount or rate that additional traffic is stored to these buffers (where such was formerly restricted).

In any case, when the decision 304 determines that flow control is not desired, the flow control processing 300 returns to repeat the operation 302 and subsequent blocks so that additional monitoring can be performed. On the other hand, when the decision 304 determines that flow control is desired, then the scheduler associated with the switch system is notified 306 of the monitored traffic conditions. Then, the scheduling of traffic to the ports is altered 308 based on the monitored traffic conditions. For example, when the amount of traffic buffered for a particular port is high, the scheduling of the traffic to the port can be altered 308 such that limited or no traffic is thereafter scheduled for the port. On the other hand, when the monitored traffic conditions indicate that the traffic at a particular port is low, the scheduling of the traffic to the port can be altered 308 such that additional traffic can be scheduled for the port. Hence, the scheduling of the traffic to the ports can be dynamically altered 308 in accordance with monitored traffic conditions. Following the operation 308, the flow control processing 300 returns to repeat the operation 302 and subsequent operations so that additional flow control processing 300 can be performed.

The flow control processing 300 depicted in FIG. 3 can be applied on a per-port basis or on a group of the ports. However, it is normally preferable that the flow of traffic to the ports be dynamically controlled on a per-port basis. In such case, each port can receive a flow of traffic that is commensurate to their availability to buffer (queue) traffic.

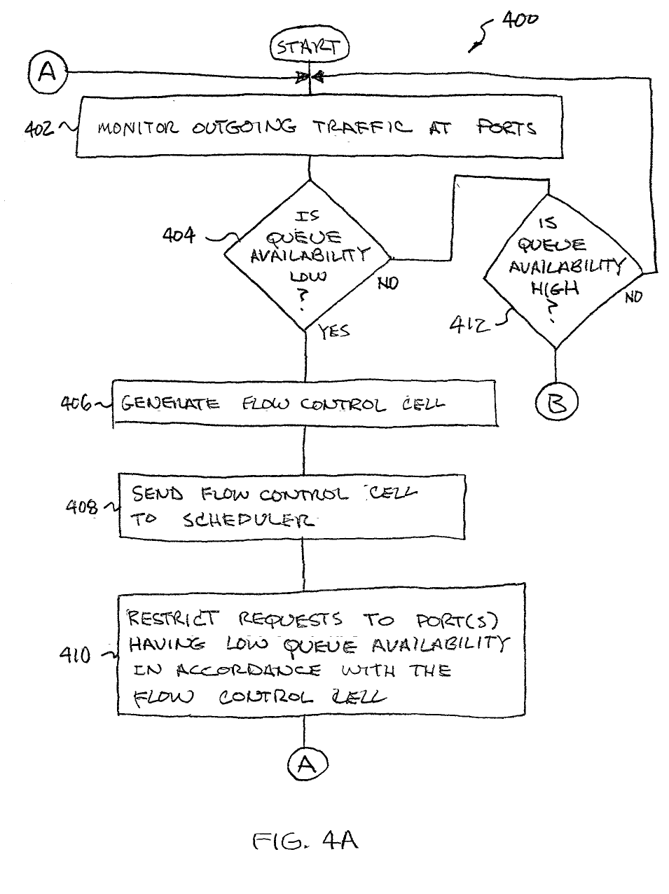

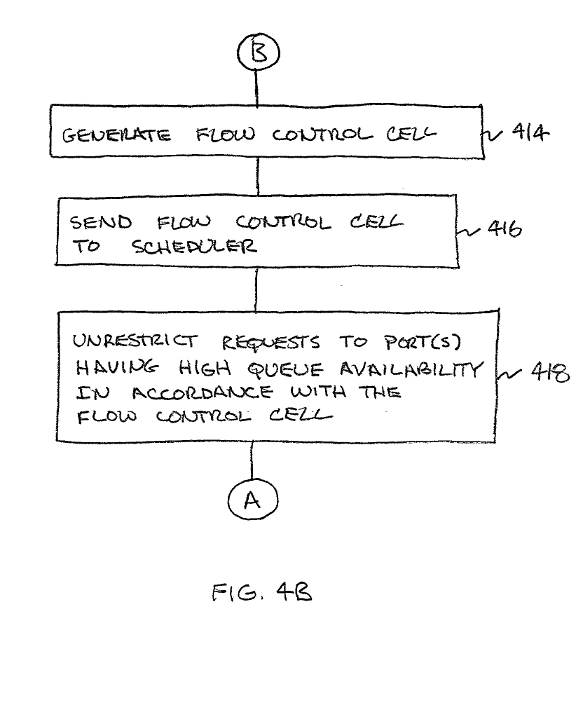

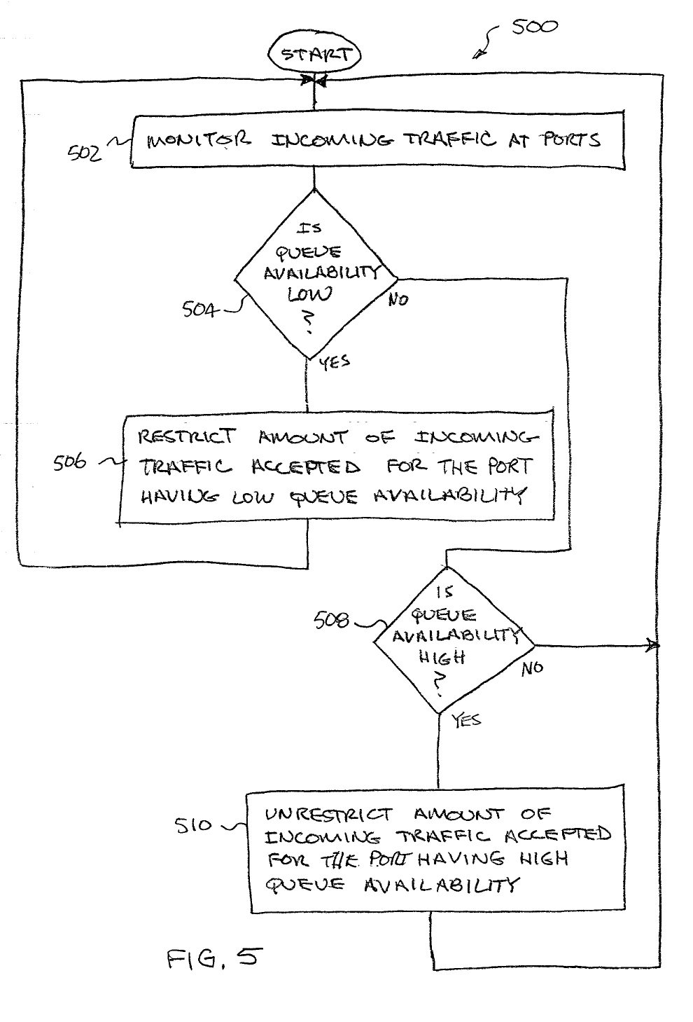

A switch system typically has a transmit side and a receive side. The processing presented in FIGS. 4A and 4B pertain to receive-side operations. The processing presented in FIG. 5 pertains to transmit-side operations. In one embodiment, the receive-side operations are performed by a switching apparatus together with a virtual queue manager or traffic manager, and the transmit-side operations are performed by a virtual queue manager or a traffic manager.

FIGS. 4A and 4B are flow diagrams of flow control processing 400 according to a more detailed embodiment of the invention. The flow control processing 400 monitors 402 outgoing traffic at ports of a switch system. The switch system operates to switch incoming traffic from one or more of a plurality of input ports to one or more of a plurality of output ports. Hence, the monitoring 402 of outgoing traffic at the ports typically involves monitoring queue availability with respect to virtual queues that buffer the outgoing traffic for respective ports. Hence, once the outgoing traffic at the ports has been monitored 402, a decision 404 determines whether queue availability is low. When the decision 404 determines that queue availability is low, then a flow control cell is generated 406. Here, the flow control cell contains information to indicate that the outgoing traffic at one or more ports is backed up and thus the rate at which additional outgoing traffic for that port is passed through the switch system should be slowed or stopped.

Next, the flow control cell is sent 408 to the scheduler. Here, the switch system includes a scheduler that receives requests to send traffic through the switch system. The scheduler then accepts or declines the requests to switch data through the switch system. After the flow control cell has been sent 408 to the scheduler, the requests to the one or more ports having low queue availability are restricted 410 in accordance with the flow control cell. At this point, the flow control processing 400 has restricted 410 the flow of additional outgoing traffic to those of the outgoing ports facing congestion. The congestion causes the virtual queues associated with those ports to fill up with outgoing traffic waiting to be transmitted. Hence, by restricting 410 the requests to those ports, the scheduler is able to assert flow control (e.g., back pressure) when the virtual queues are unable to safely store additional traffic. Following the operation 410, the flow control processing 400 returns to repeat the operation 402 and subsequent operations so that flow control can be achieved dynamically by closely tracking queue availability.

On the other hand, when the decision 404 determines that queue availability is not low, a decision 412 determines whether queue availability is high. Here, the queue availability at each of the ports (namely, the virtual queues associated with those ports) is monitored 402. Hence, when the decision 412 determines that queue availability is high, the amount of traffic stored in the virtual queues having high queue availability is low, and thus additional traffic can be handled by such queues. In this case, a flow control cell is generated 414. Here, the flow control cell is used to indicate those one or more ports of the switch system that currently have high queue availability. In this situation, the flow control cell typically pertains to or effects only those of the ports that previously have had flow control applied to restrict traffic thereto but which now no longer needs such flow control assistance. The flow control cell is then sent 416 to the scheduler. Thereafter, assuming that the traffic is presently restricted to those one or more ports, the flow control processing 400 operates to unrestrict 418 the requests to the one or more ports having high queue availability in accordance with the flow control packet. Hence, if traffic is restricted such as by operation 410, later when queue availability becomes high, the granting of requests to that port can be unrestricted 418. Likewise, thereafter, when queue availability was previously high, when the queue availability goes low, the requests to the associated port can be thereafter restricted 410. Following the operation 418, the flow control processing 400 returns to repeat the operation 402 and subsequent operations so that the flow control processing 400 can be performed in a dynamic manner.

It should be noted that the decisions 404 and 412 need not be based on the same threshold condition. For example, queue availability can be determined to be low if less than 10% of the storage capacity of the queue is available for storage of additional traffic. Further, queue availability can be determined to be high if more than 50% of the storage capacity of the queue is available for storage of additional traffic.

FIG. 5 is a flow diagram of transmit-side flow control processing 500 according to one embodiment of the invention. The transmit-side flow control processing 500 is separate and independent processing from the receive-side flow control processing 400 illustrated in FIGS. 4A and 4B.

The transmit-side flow control processing 500 initially monitors 502 incoming traffic at various ports. A decision 504 then determines whether queue availability is low at one or more of the ports. The transmit-side flow control processing 500 is described with respect to a particular one of the ports, though multiple ports can be simultaneously or serially processed. Hence, the decision 504 determines whether queue availability is low at the particular port. When the decision 504 determines that queue availability is low, then the amount of incoming traffic accepted for the port having low queue availability is restricted 506. Following the operation 506, the transmit-side flow control processing 500 returns to repeat the decision 502 and subsequent operations so that additional flow control can be performed.

On the other hand, when the decision 504 determines that queue availability is not low, then a decision 508 determines whether queue availability is high. When the decision 508 determines that queue availability is high, then the amount of incoming traffic accepted for the port having high queue availability is unrestricted 510. Following the operation 510, as well as directly following the decision 508 when the queue availability is not high, the transmit-side flow control processing 500 returns to repeat the operation 502 and subsequent operations so that additional flow control can be performed.

It should be noted that the decisions 504 and 508 need not be based on the same threshold condition. For example, queue availability can be determined to be low if less than 10% of the storage capacity of the queue is available for storage of additional traffic. Further, queue availability can be determined to be high if more than 50% of the storage capacity of the queue is available for storage of additional traffic.

As an example, the flow control cell is a multi-field cell with a format much like other non-control cells for unicast or multicast. The cell could also be considered a packet. A representative cell format is provided in Table 1 below.

TABLE 1

| Field Name | Description | |
|---|---|---|
| SOC | Start-Of-Cell | |
| CCH | Cell Control Header | |
| | Ctype | Idle, Unicast Request, Multicast Request, Flow |
| | | Control |
| | QoS/FC | Class/Priorities or Flow Control bits |
| | Misc. | Main/Aux., Start-of-Frame, Payload Valid, |
| | | Others |
| | CRB | Cell Request Bitmap |

| | |
|---|---|
| CRC | Cyclic Redundancy Check |
| CPD | Payload Header |
| CPL | Cell Payload |

The general cell format includes a Start-Of-Cell (SOC), Cell Control Header (CCH), a Cyclic Redundancy Check (CRC), a Payload Header (CPD), and a Cell Payload (CPL). A flow control cell can be distinguished from other cells by the CCH that includes a field (Ctype) to identify cell type. When the Ctype field of the CCH indicates Flow Control, the cell is a flow control cell. The CCH of the flow control cell also includes a field (FC) that contains flow control information (i.e., Flow Control bits). The flow control cell could also, but need not, carry data in the CPL.

Each port can transmit a flow control cell (Ctype=Flow Control) to provide flow control information (e.g., Flow Control Bits) to a flow control manager or scheduler. As discussed above, the flow control information causes the scheduler to restrict grants of requests for data transfer to the congested port(s). In one embodiment, the restricting of grants is performed by enabling/disabling arbiters within the scheduler.

In one embodiment, the flow control information (Flow Control Bits) provided within the flow control cell for a thirty-two (32) port switch system can be as follows:

| PORT | Flow Control Bit |
|---|---|
| 1 | 0 |
| 2 | 0 |
| 3 | 0 |
| 4 | 1 |
| 5 | 0 |
| 6 | 1 |
| * | |
| * | |
| * | |
| 31 | 0 |
| 32 | 1 |

In this embodiment, the flow control information is one bit per port. The bit indicating whether backpressure should be invoked (“1”) or revoked (“0”). In other words, a flow control bit of “1” indicates that congestion is present at the associated port and thus restrict the flow of additional traffic to that port, and a flow control bit of “0” indicates that congestion is not present at the associated port and thus unrestrict the flow of additional traffic to that port.

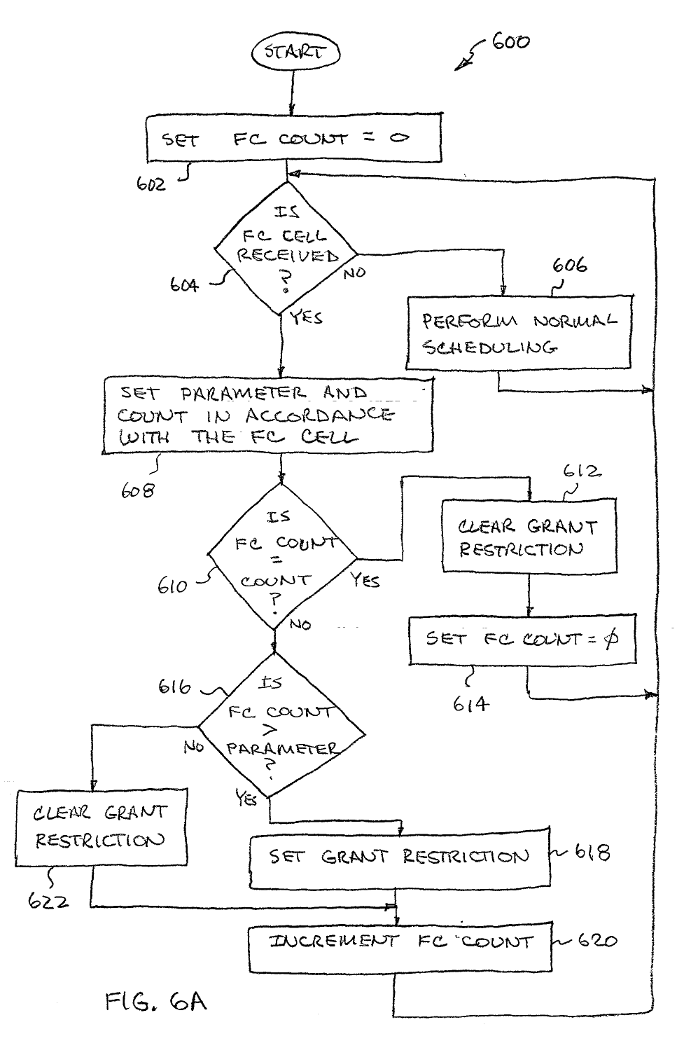

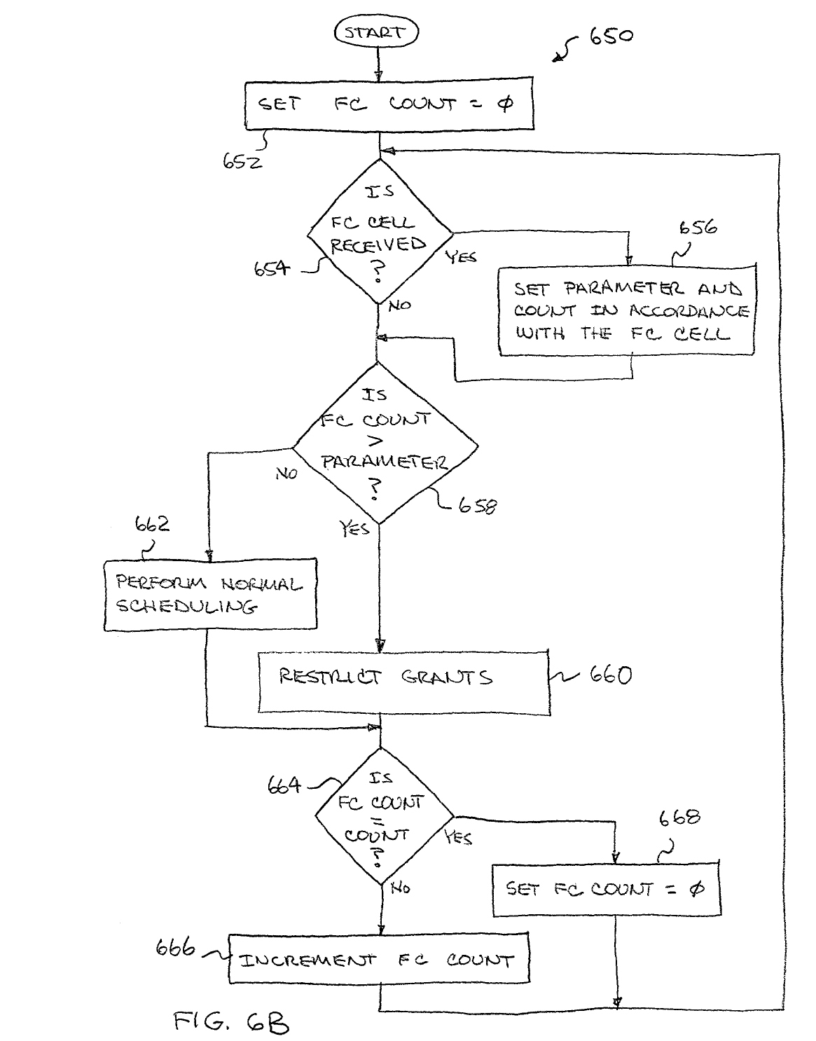

In another embodiment, the flow control information indicates a flow control amount. In one implementation, the flow control information includes two variables m and n for each port. The flow control amount is then determined by m/n. In this implementation, two variables, count and parameter, are used. These count and parameter variables are thus directly related to m and n or the flow control amount. The count is n−1 and the parameter is m−1. Table 2 provided below indicates the relationship of the desired flow control amount to the count and parameter variables associated with FIG. 6A or FIG. 6B.

TABLE 2

| Flow Control | Count (n-1) | Parameter (m-1) |
|---|---|---|
| 0% | 1 | 2 |
| 25% | 3 | 0 |
| 50% | 1 | 1 |
| 75% | 3 | 2 |
| 100% (backpressure) | 1 | 0 |

In one embodiment, these five different flow control levels or states can be defined by three (3) flow control bits for each port. For example, 0% flow control can be defined as “000”, 25% flow control can be defined as “001”, 50% flow control can be defined as “010”, 75% flow control can be defined as “011”, and 100% flow control can be defined as “100”.

FIG. 6A is a flow diagram of flow control processing 600 in accordance with a flow control amount according to one embodiment of the invention. The flow control processing 600 is, for example, performed by a scheduler or a flow control manager. Here, the flow control processing 600 operates to interact with a scheduler to restrict grants of request for data transfer in accordance with count and parameter variables that effectuate a flow control amount.

The flow control processing 600 initially sets 602 a flow control count (FC COUNT) equal to zero (0) 602. Then, a decision 604 determines whether a flow control (FC) cell has been received. When the decision 604 determines that a flow control cell has not been received, then normal scheduling processing is performed 606. Here, the scheduling operates to arbitrate amongst incoming requests and to grant certain of the requests while honoring any previously set grant restrictions.

On the other hand, when the decision 604 determines that a flow control cell has been received, then parameter (PARAMETER) and count (COUNT) variables are set 608 in accordance with the flow control cell. Here, it is assumed that the flow control cells either contain the parameter and count variables or processing is able to produce such variables from the information (e.g., flow control information) provided with the flow control cell. Then, a decision 610 determines whether the flow control count is equal to the count variable. When the decision 610 determines that the flow control count is equal to the count variable, then grant restrictions are cleared 612. In other words, in this case, the flow control processing 600 serves to remove or clear any grant restrictions that have been previously set such that flow control is no longer limiting traffic. Following the operation 612, the flow control count is set 614 is set to zero (0).

On the other hand, when the decision 610 determines that the flow control count is not equal to the count variable, then a decision 616 determines whether the flow control count is greater than the parameter variable. When the decision 616 determines that the flow control count is greater than the parameter variable, then grant restrictions are set 618. Here, when the grant restriction is set 618, the scheduler operates to restrict the grants of request for data or traffic transfer to the one or more ports having congestion. It should be understood that the flow control processing 600 can be performed on a per port basis with the count and parameter variables being associated with a particular port. In other words, different ports can utilize different count and parameter variables to provide different levels of flow control. Following the operation 618, the flow control count is incremented 620. Alternatively, when the decision 616 determines that the flow control count is not greater than the parameter variable, then the grant restriction is cleared 622. Following the operation 622, the flow control processing 600 performs the operation 620 to increment the flow control count. Further, following the operations 606, 614 and 620, the flow control processing 600 returns to repeat the decision 604 and subsequent operations so that subsequently received flow control cells can be similarly processed.

FIG. 6B is a flow diagram of flow control processing 650 in accordance with a flow control amount according to another embodiment of the invention. The flow control processing 650 is, for example, performed by a scheduler or a flow control manager. Here, like the flow control processing 600 in FIG. 6A, the flow control processing 650 operates to interact with a scheduler to restrict grants of request for data transfer in accordance with count and parameter variables that effectuate a flow control amount.

The flow control processing 600 initially sets 602 a flow control count (FC COUNT) equal to zero (0) 652. Then, a decision 654 determines whether a flow control (FC) cell has been received. When the decision 654 determines that a flow control cell has been received, then parameter (PARAMETER) and count (COUNT) variables are set 656 in accordance with the flow control cell. Here, it is assumed that the flow control cells either contain the parameter and count variables or processing is able to produce such variables from the information (e.g., flow control information) provided with the flow control cell. On the other hand, when the decision 654 determines that a flow control cell has not been received, as well as following operation 656, a decision 658 determines whether the flow control count is greater than the parameter variable. When the decision 658 determines that the flow control count is greater than the parameter variable, then grants (i.e., by the scheduler) are restricted 660. Here, when the grants are restricted 660, the scheduler operates to restrict the grants of requests for data or traffic transfer to the one or more ports having congestion. Alternatively, when the decision 658 determines that the flow control count is not greater than the parameter variable, then normal scheduling processing is performed 606. Here, the scheduling operates without flow control restrictions to arbitrate amongst incoming requests so as to grant certain of the requests.

Following operations 660 and 662, a decision 664 determines whether the flow control count is equal to the count variable. When the decision 664 determines that the flow control count is not equal to the count variable, then the flow control count is incremented 666. On the other hand, when the decision 664 determines that the flow control count is equal to the count variable, then the flow control count is set 668 is set to zero (0). Further, following the operations 666 and 668, the flow control processing 600 returns to repeat the decision 654 and subsequent operations so that subsequently received flow control cells can be similarly processed.

It should be understood that the flow control processing 650 can be performed on a per port basis with the count and parameter variables being associated with a particular port. In other words, different ports can utilize different count and parameter variables to provide different levels of flow control.

In either embodiments of the flow control processing 600, 650 shown in FIGS. 6A and 6B, the flow control cell (FC cell) need only be sent to the scheduler or flow control manager when there is to be a change or adjustment to the current flow control settings. However, if desired, flow cells can be sent more frequently.

To further illustrate operation of the invention according to one embodiment, Tables 3 and 4 are provided below. However, it should be recognized that the invention contemplates various other embodiments. Table 3 indicates detection of traffic congestion and then activation of flow control. Table 4 indicates detection of relief from traffic congestion and then deactivation of flow control. These tables show on a per-port basis the progression of the flow control through components of the switch system over a number of sequential cycles. The components of the switch system referenced with these tables include an ingress Traffic Manager (TM_in), VQM's virtual input queue for egress (VIQ), scheduler (SCH), VQM's virtual output queue for ingress (VOQ), and egress Traffic Manager (TM_out). These components can, for example, respectively correspond to traffic manager 110, the VQM 106, the scheduler 114, the VQM 104, and the traffic manager 108 illustrated in FIG. 1.

TABLE 3

| Cycle | TM_in | VOQ | SCH | VIQ | TM_out |
|---|---|---|---|---|---|
| Cycle 1 | | | | | Congestion |
| | | | | | Detected |
| Cycle 2 | | | | | FC Frame |
| | | | | | To VIQ |
| Cycle 3 | | | | FC frame | |
| | | | | from | |
| | | | | TM_out | |
| | | | | VIQ over | |
| | | | | queue | |
| | | | | threshold | |
| Cycle 4 | | | | FC cell | |
| | | | | To SCH | |
| Cycle 5 | | | FC cell | | |
| | | | Set | | |
| | | | FC | | |
| | | | settings | | |
| Cycle 6 | | | Restrict | | |
| | | | grants for | | |
| | | | congested | | |
| | | | ports | | |
| Cycle 7 | TM | VOQ | Restrict | VIQ | TM sending |
| . . . | sending | receiving | grants for | receiving | Egress |
| Cycle n | frames | ingress frame | congestion | egress cell | frame |
| | to VOQ | | | | |
| Cycle | | VOQ over | | | |
| n + 1 | | queue | | | |
| | | threshold | | | |
| Cycle | | FC Frame to | | | |
| n + 2 | | TM_in | | | |
| Cycle | FC | | | | |
| n + 3 | Frame | | | | |
| | received | | | | |
| Cycle | Restrict | | | | |
| n + 4 | frames | | | | |
| | sending | | | | |

The processing detailed in Table 3 can be generally explained as follows. At cycle 1, the traffic manager (TM_out) detects traffic congestion. In cycle 2, the traffic manager (TM_out) sends a flow control (FC) frame to the virtual input queue (VIQ). In cycle 3, the virtual queue (VIQ) can detect traffic congestion in one of two different ways. In the first way, the virtual queue (VIQ) receives the flow control (FC) frame from the traffic manager (TM_out) that was sent in cycle 2. Alternatively, the virtual queue (VIQ) can itself detect an over queue threshold condition, meaning that its associated queue is almost completely filled with traffic. In cycle 4, the virtual queue (VIQ) can send a flow control (FC) cell to the scheduler when the virtual queue (VIQ) detects congestion at cycle 3 under either of the ways. Next, the scheduler receives the flow control (FC) cell at cycle 5 and proceeds to set flow control (FC) settings. As an example, the flow control (FC) settings can be used to provide a flow control rate. In one example, as discussed above, the flow control (FC) settings can pertain to count and parameter variables. Next, in cycle 6, the scheduler operates to restrict grants to those ports that have been identified as having traffic congestion. Thereafter, at cycle 7 and continuing to cycle n, the switch system switches traffic between input ports and output ports while restricting grants to those ports having congestion. Then, at cycle n+1, the virtual queue (VOQ) detects an over queue threshold condition, meaning that its queue is substantially filled with traffic. Then, in cycle n+2, the virtual queue (VOQ) produces and sends a flow control (FC) frame to the traffic manager (TM_in). In cycle n+3, the traffic manager (TM_in) receives the flow control (FC) frame. In cycle n+4, the traffic manager (TM_in) restricts sending of additional frames to the virtual queue (VOQ).

As Table 3 indicates, traffic congestion is initially detected at the output-side of the switch system. The scheduler is then informed of the traffic congestion such that it thereafter restricts grants to those ports having congestion. The scheduler does not serve to inform the input side of the switch system of the congestion occurring on the output side. Instead the input side can detect congestion at the virtual queue (VOQ) based on its queue threshold condition. When necessary, the virtual queue (VOQ) can inform the input side traffic manager of its congestion such that additional frames of traffic being sent to the virtual queue (VOQ) are restricted.

TABLE 4

| Cycle | TM_in | VOQ | SCH | VIQ | TM_out |
|---|---|---|---|---|---|
| Cycle 1 | | | | | Congestion |
| | | | | | relieved |
| Cycle 2 | | | | | FC Frame |
| | | | | | To VIQ |
| Cycle 3 | | | | FC frame | — |
| | | | | from | |
| | | | | TM_out | |
| | | | | VIQ under | |
| | | | | queue | |
| | | | | threshold | |
| Cycle 4 | | | | FC cell | |
| | | | | To SCH | |
| Cycle 5 | | | FC cell | | |
| | | | clear | | |
| | | | FC | | |
| | | | settings | | |
| Cycle 6 | | | Release | | |
| | | | granting | | |
| | | | restriction | | |
| Cycle 7 | TM | VOQ | Normal | VIQ | TM sending |
| . . . | sending | receiving | arbitration | receiving | Egress |
| Cycle n | frames | ingress frame | | egress cell | frame |
| | to VOQ | | | | |
| Cycle | | VOQ under | | | |
| n + 1 | | queue | | | |
| | | threshold | | | |
| Cycle | | FC Frame to | | | |
| n + 2 | | TM_in | | | |
| Cycle | FC | | | | |
| n + 3 | Frame | | | | |
| | received | | | | |
| Cycle | Resume | | | | |
| n + 4 | frames | | | | |
| | sending | | | | |

Table 4 indicates the deactivation of previously activated flow control. In other words, the sequence of operations illustrated in Table 4 occur when previously detected traffic congestion has been relieved. In cycle 1, the traffic manager (TM_out) has detected relief from traffic congestion (i.e., no traffic congestion). In cycle 2, the traffic manager (TM_out) produces and sends a flow control (FC) frame to the virtual queue (VIQ). In cycle 3, the virtual queue (VIQ) detects relief from traffic congestion in either one of two different ways. In a first way, the virtual queue (VIQ) receives the flow control (FC) frame from the traffic manager (TM_out). In a second way, the virtual queue (VIQ) itself determines an under queue threshold condition. The under queue threshold condition indicates that the associated queue is able to store substantially additional amounts of traffic. In either case, in cycle 4, the virtual queue (VIQ) sends a flow control (FC) cell to the scheduler. In cycle 5, the scheduler receives the flow control (FC) cell and clears the flow control (FC) settings. Once the flow control (FC) settings are cleared, the scheduler no longer restricts the granting of requests for transfer of data. Hence, in cycle 6, the scheduler effects the release of the prior restrictions on the granting of requests. In cycle 7 and subsequent cycles, the scheduler performs normal operations with respect to the granting of requests. At this point, there is no flow control being imposed on the output side of the switch system. However, in this example, flow control is still restricting frames at the input side of the switch system. In cycle n+1, the virtual queue (VOQ) detects an under queue threshold condition. In other words, the virtual queue (VOQ) detects that it is now capable of storing substantial additional amounts of traffic. In cycle n+2, the virtual queue (VOQ) produces and sends a flow control (FC) frame to the traffic manager (TM_in). In cycle n+3, the traffic manager (TM_in) receives the flow control (FC) frame. Then, in cycle n+4, the traffic manager (TM_in) ends the restriction of sending frames to the virtual queue (VOQ) and thus resumes sending frames without flow control.

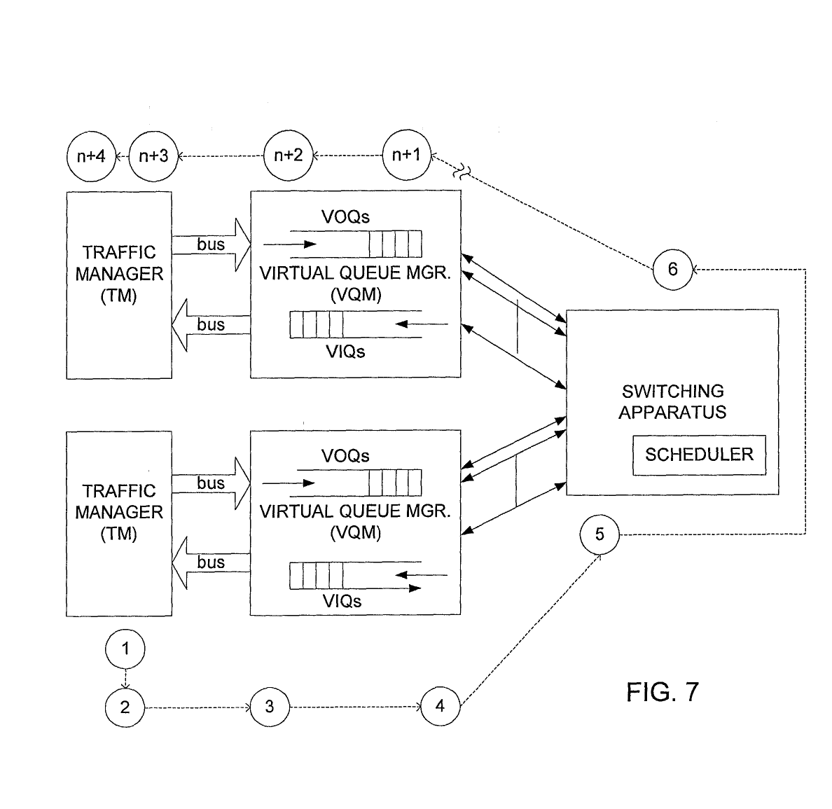

FIG. 7 is a block diagram of a switch system that generally resembles the switch system 100 illustrated in FIG. 1. In general, the traffic managers (TMs) and the virtual queue managers (VQMs) support bidirectional traffic as indicated in FIG. 7. The circled numbers 1, 2, 3, 4, 5, 6, . . . n+1, n+2, n+3 and n+4 correspond to identified cycles provided in Tables 3 and 4. Hence, the circled numbers depicted in FIG. 7 indicate where the cycles are performing their operation with respect to activation or deactivation of flow control in a switching system according to one embodiment of the invention. The invention is suitable for use with various switch system designs. For example, the invention is well suited for used with the switch system architectures described in U.S. application Ser. No. 09/759,434, filed Jan. 12, 2001, and entitled “SWITCH FABRIC CAPABLE OF AGGREGATING MULTIPLE CHIPS AND LINKS FOR HIGH BANDWIDTH OPERATION”, the content of which is hereby incorporated by reference.

The switch, switching apparatus or switch system can be represented by a variety of devices or apparatuses. Examples of such devices or apparatuses include: switches, routers, bridges, gateways, etc.

The invention is preferably implemented in hardware, but can be implemented in a combination of hardware and software. Such software can also be embodied as computer readable code on a computer readable medium. Examples of computer readable code includes program instructions, such as machine code (e.g., produced by a compiler) or files containing higher level code that may be executed by a computer using an interpreter or other means. The computer readable medium is any data storage device that can store data which can be thereafter be read by a computer system. Examples of the computer readable medium include read-only memory, random-access memory, CD-ROMs, magnetic tape, optical data storage devices, or carrier waves. In the case of carrier waves, the invention can be embodied in a carrier wave travelling over an appropriate medium such as airwaves, optical lines, electric lines, etc. The computer readable medium can also be distributed over a network coupled computer system so that the computer readable code is stored and executed in a distributed fashion.

The advantages of the invention are numerous. Different embodiments or implementations may yield one or more of the following advantages. One advantage of the invention is that flow control (or back pressure) can be provided for a switch system in a bandwidth efficient manner. Another advantage of the invention is that a scheduler that arbitrates amongst various requests to switch data can also incorporate flow control.

The many features and advantages of the present invention are apparent from the written description and, thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A method for managing congestion of traffic at a plurality of ports of a switch system, the switch system having at least a scheduler, said method comprising:
(a) monitoring outgoing traffic at the ports of the switch to identify traffic conditions at each of the ports;
(b) notifying the scheduler of the switch system of the traffic conditions; and
(c) scheduling of traffic to the ports by the scheduler based in part on the traffic conditions provided to the scheduler by said notifying (b).

2. A method as recited in claim 1, wherein said monitoring (a) operates to independently monitor the outgoing traffic queued for each of the ports to identify the traffic conditions at each of the ports.

3. A method as recited in claim 2, wherein said scheduling (c) by the scheduler operates to independently adjust the rate of traffic delivery to each of the ports based on the respective traffic conditions at the ports.

4. A method as recited in claim 1, wherein the switch system includes at least one queue for each of the ports, and
wherein said monitoring (a) of the outgoing traffic operates to monitor an amount of the outgoing traffic stored in each of the queues.

5. A method as recited in claim 1, wherein said notifying (b) comprises:
(b1) forming a flow control packet including an indication of the traffic conditions at one or more of the ports; and
(b2) sending the flow control packet to the scheduler.

6. A method as recited in claim 1, wherein said scheduling (c) by the scheduler operates to independently adjust the rate of traffic delivery to each of the ports.

7. A method for applying flow control to a multi-port switch system having at least a scheduler, said method comprising:
detecting congestion at a particular port of the multi-port switch system;
notifying the scheduler of the detected congestion; and
restricting granting of requests to send additional data to the particular port of the multi-port switch system to ameliorate the detected congestion at the particular port.

8. A method for managing congestion of traffic at a plurality of ports of a switch system, the switch system having at least a scheduler, said method comprising:
monitoring outgoing traffic at the ports of the switch to identify traffic conditions at each of the ports;
determining whether flow control is desired based on the traffic conditions;
notifying the scheduler of the switch system of the traffic conditions when said determining determines that flow control is desired; and
altering scheduling of traffic to the ports based on the traffic conditions provided to the scheduler by said notifying.

9. A method as recited in claim 8, wherein said determining operates to compare the traffic conditions to a threshold value.

10. A method as recited in claim 8, wherein the traffic conditions indicate whether congestion is present.

11. A method as recited in claim 8, wherein the traffic conditions indicate a degree of congestion.

12. A method as recited in claim 8, wherein the traffic conditions further indicate a flow reduction value.

13. A method for managing congestion of traffic at a plurality of ports of a switch system, the switch system having at least a scheduler, said method comprising:
monitoring outgoing traffic at the ports of the switch to identify traffic conditions at each of the ports;
producing flow control information for each of the ports based on the traffic conditions at each of the ports; and
altering scheduling of traffic to the ports based on the flow control information.

14. A method as recited in claim 13, wherein said altering is performed on a per port basis.

15. A method as recited in claim 13, wherein said method further comprises:
providing the scheduler of the switch system with the flow control information.

16. A method as recited in claim 15, wherein said providing comprises:
forming a flow control cell based on or including the flow control information; and
transmitting the flow control cell to the scheduler.

17. A method as recited in claim 15, wherein the scheduler comprises a flow control manager.

18. A method as recited in claim 13, wherein the switch system further includes at least a flow control manager.

19. A method as recited in claim 18, wherein said method further comprises:
providing the flow control manager of the switch system with the flow control information.

20. A method as recited in claim 19, wherein said providing comprises:
forming a flow control cell based on or including the flow control information; and
transmitting the flow control cell to the flow control manager.

21. A method as recited in claim 13,
wherein said altering is performed on a per port basis, and
wherein the scheduler is operatively connected to a flow control manager, the flow control manager interacts with the scheduler to alter the scheduling of traffic to the ports in accordance with the flow control information.

22. A method as recited in claim 13, wherein the flow control information comprises flow control amounts for at least a plurality of the ports.

23. A switch system, comprising:
a switch unit that switches data through said switch system;
a scheduler that receives requests to transfer blocks of data through said switch system and selectively concurrently permits one or more of the requests to transfer blocks of data through said switch unit; and
a flow control manager that receives flow control information and alters the amount of or rate that requests to transfer blocks of data through said switch unit are permitted by said scheduler based on the flow control information.

24. A switch system as recited in claim 23, wherein said switch system supports a plurality of ports, and wherein the flow control information is derived from congestion information that indicates presence or absence of congestion at one or more of the ports.

25. A switch system as recited in claim 23, wherein said switch system supports a plurality of ports,
wherein said switch system further comprises at least one receive-side queue and at least one transmit-side queue for each of the ports, and
wherein the flow control information is dependent upon an amount or rate of congestion at said receive-side queue.

26. A switch system as recited in claim 25, wherein said switch system further comprises:
a traffic manager operatively connected to at least said receive-side queue, said traffic manager monitors said receive-side queue and produces the flow control information that is supplied to said flow control manager.

27. A switch system as recited in claim 23, wherein said switch system supports a plurality of ports,
wherein said switch system further comprises at least one receive-side queue and at least one transmit-side queue for each of the ports, and
wherein said flow control manager receives the flow control information associated with said receive-side queue and subsequently alters the amount of or rate that requests to transfer blocks of data through said switch unit to said receive-side queue are permitted by said scheduler.

28. A switch system as recited in claim 27, wherein said flow control manager does not alter the amount of or rate that requests to transfer blocks of data through said switch unit to said transmit-side queue are permitted by said scheduler.

29. A switch system, comprising:
a switch unit that switches data through said switch system; and
a scheduler that receives requests to transfer blocks of data through said switch system, receives flow or traffic information, and selectively concurrently permits one or more of the requests to transfer blocks of data through said switch unit in accordance with the flow or traffic information such that the amount of or rate that requests to transfer blocks of data through said switch unit are altered dependent on the flow or traffic information.
